(19) United States
(12) Patent Application Publication
(10) Pub. No.: US 2004/0103053 A1
(43) Pub. Date: May 27, 2004

(54) System and method for determining the value and optimal exercise of employee stock options

(76) Inventor: Ronald D. Rudkin, Danville, CA (US)

Correspondence Address: GOODWIN PROCTER LLP, 599 Lexington Avenue, New York, NY, 10022, US

(21) Appl. No.: 10/601,122

(22) Filed: Jun. 20, 2003

Related U.S. Application Data
(60) Provisional application No. 60/390,333, filed on Jun. 20, 2002.

(51) Int. Cl. G06F 17/60

(52) U.S. Cl. 705/36

(57) ABSTRACT

The present invention determines the cost to shareholders and the value to employee of stock options (ESOs). The invention addresses the unique features that differentiate ESOs from exchange-traded options (ETOs), including transferability and vesting restrictions, forfeiture, blackout dates and non-traditional features. Non-traditional features include performance vesting, “indexed” options (option's strike price is tied to an index) and “repriceable” options (option's strike price may be reset if the option becomes too far “under water”).

### CROSS-REFERENCE TO RELATED APPLICATIONS

This application claims the benefit of U.S. Provisional Patent Application No. 60/390,333, filed Jun. 20, 2003, which is hereby incorporated by reference in its entirety.

### BACKGROUND OF THE INVENTION

1. Field of the Invention

This invention generally relates to a system and method for determining the value and optimal exercise of employee stock options (“ESOs”).

2. Related Background Art

ESOs give an employee the right but not the obligation to purchase a stated number of shares of the company's stock for a stated price on or before a given date. ESOs are essentially call options that are given to employees.

The use of ESOs by US firms has increased dramatically during the last few years. ESOs have emerged as the single biggest component of compensation for US executives (see, Hall, B. J and Murphy, K. J, “Stock Options for Undiversified Executives”, Working Paper 8052, National Bureau of Economic Research, Inc. (December 2000)(“Hall and Murphy [2000B]”). In fiscal 1999, 94 percent of the S&P 500 companies granted ESOs to their top executives compared to 82 percent in 1992. In addition to the importance of this form of compensation, the continuing debate over the proper reporting of ESO expenses and the recent announcements that the cost of ESOs will be treated as compensation expense by several large firms (e.g., Coca Cola and General Electric) have heightened interest in the valuation of ESOs.

The accurate valuation of ESOs is important to companies for at least two reasons. First, it enables a firm to accurately report labor related costs. Second, it provides the inputs required to design compensation programs that provide the desired retention and incentive benefits at the minimum cost to the company. To design effective compensation programs the company must know both the cost of the ESO program to the company and the value of the ESOs to its employees.

The cost of ESOs has traditionally been valued using the Black-Scholes model, which was initially designed for valuing exchange-traded options (“ETOs”). However, as discussed in detail below, ESOs have features that make them substantially different from ETOs. By failing to reflect these features, the traditional valuation methods produce results that are greatly in error. For example, the results reported in the empirical literature show that the Black-Scholes model can overstate the value of ESOs by more than 50 percent (see, Huddart, S. and Lang, M, “Employee Stock Option Exercises: An empirical Analysis”, The Journal of Accounting and Economics (1996)).

The key features that differentiate ESOs from ETOs are discussed below.

### A. Non-Transferability

Unlike ETOs, ESOs cannot be traded. Hence, there is no market price for them and the only way for employees to obtain value to meet liquidity requirements or to attempt to diversify their portfolio is to exercise them. However, the value the employee receives from exercising an ESO is the ESO's intrinsic value (i.e., stock price minus the ESO's strike price) instead of a market price that would equal the sum of the ESO's intrinsic value and its time value (i.e., the value associated with the possibility of future stock price increases). In addition, employees, unlike outside investors, are generally unable to hedge the risk the option will decrease in value and are typically poorly diversified.

For these reasons, employees will tend to place a lower value on ESOs and tend to exercise them earlier than would an outside investor. The net result is that ESOs will tend to be less costly to the company and worth less to employees than predicted by the Black-Scholes model.

### B. Vesting Requirements

Unlike ETOs that can be exercised at any time, ESOs can be exercised only after they are vested. For some plans vesting occurs after a preset number of years, usually two to four years. This type of vesting is termed “cliff” vesting. For other plans a certain percentage of the ESOs vest each year over several years (e.g., one quarter of the shares granted vest each year over a four year period). This type of vesting is usually referred to as “graded” vesting. Graded vesting is the most common type of vesting schedule.

Unlike ETOs, which typically have durations of three to 12 months, ESOs typically have an option duration of ten years. In Murphy, K. J., “Executive Compensation” In Ashenfelter, 0. and Card, D. (Eds.) Handbook of Labor Economics, Vol. 3, Amsterdam: North-Holland, pages 2485-2563 (1999), Murphy noted: “ . . . the Black-Scholes formula assumes constant dividend yields, and stock-price volatilities, assumptions which seem sensible for short-term traded options (usually expiring in six months or less) but less sensible for options expiring in a decade.” Consequently, a shortcoming of the present models is that they are unable accommodate key input parameters to vary with time.

### C. Exercise Features

ESOs can be exercised any time after the ESO vests and on or before the option's expiration date. This feature is to be contrasted with the Black-Scholes model, which assumes that an option can be exercised only at its expiration date (“European” option).

### D. Forfeiture Provisions

ESO plans usually require employees to forfeit their ESOs if they leave the firm prior to the option vesting, and either forfeit or exercise vested options shortly after leaving the firm. Holders of vested ESOs will, of course, exercise them only if they are “in the money.” The possibility of forfeiture or “forced exercise” reduces the value of an ESO compared to an ETO.

### E. Non Standard Features

In addition, ESOs tend to have non-standard features, which tend to further reduce the cost and value of ESOs compared to ETOs. (The exception is the repriceable option. All else being equal, this feature will increase the value of an ESO.) These non-standard features include:

Repriceable ESOs, which allow the strike price to be reset if the option is too far under water;

Performance vested ESOs, which vest only if the underlying stock price exceeds a prescribed level;

Indexed ESOs, which allow the strike price to vary according an index; and

Purchased ESOs, which require the employee to pay a portion of the strike price at the grant date and the remainder of the strike price when the ESO is exercised.

As pointed out by numerous authors (Huddart, S., “Employee Stock Options”, Journal of Accounting and Economics, Vol. 18, pages. 207-231(1994); Kulatilaka, N. and Marcus, A. J., “Valuing Employee Stock Options.” Financial Analysts Journal, pages 46-56 (November-December 1994); Rubinstein, M., “On the Accounting Valuation of Employee Stock Options”, Journal of Derivatives, (Fall 1995)), ESOs are very different from ETOs and these differences cause valuations based on the Black-Scholes model to be overstated.

In an attempt to overcome the limitations of the Black-Scholes model, Huddart, Kulatilaka et al., and Rubinstein, develop binomial tree-based models, which assume that employees make exercise decision to maximize the expected utility of terminal wealth. The models developed by them are an improvement over the Black-Scholes model in that they address the effect of risk aversion and wealth effects on ESO value. However, with the exception of the Rubinstein model, they do not reflect the effect of other factors affecting ESO value (e.g., vesting or forfeiture) nor do they address how to calibrate their models to observed measures of exercise and forfeiture behavior. Although Rubinstein's model does reflect the effect of vesting and forfeiture, it fails to consider the other factors affecting value and does not provide a means of calibrating his model to observed behavior.

In Carpenter, J. N., “The Exercise and Valuation of Executive Stock Options.” Journal of Financial Economics, Vol. 48, 1998, pages 127-158 (1998), Carpenter develops a binomial model in which exercise decisions are based on the maximization of terminal wealth; the model reflects vesting and forfeiture and can be calibrated to observed measures of exercise and forfeiture. She calibrates her model by fitting a curve through the early exercise boundary based on a model with annual time steps. She shows that a simple extension of the ordinary American option-pricing model that incorporates random, exogenous exercise and forfeiture behavior can predict exercise behavior as well as a more elaborate utility maximization model. However, this conclusion may be related to the particular parameters she used in her analysis. She used a risk aversion parameter of 2.0 in her analysis, which is usually believed to be an average level of risk aversion. It has been shown that, at high levels of risk aversion, ordinary American option-pricing models can give incorrect results (Kulatilaka and Marcus [1994]). This occurs because at high levels of risk aversion, ESO values can be inversely related to volatility. The value of exchange-traded American options are increase with increases in volatility.

All of these attempts to value ESOs are from the perspective of cost to the firm as opposed to the value of the ESO to the employee. Lambert et al. (1991) were the first to value ESOs from the perspective of the ESO holder (see, Lambert, R. A.; Larcker, D. F.; and Verrecchia, R. E., “Portfolio Considerations in Valuing Executive Compensation.” Journal of Accounting Research, Vol. 29(1), pages 129-149 (Spring 1991)). They used a certainty equivalent framework to determine the value of a European option to the ESO holder. They show that the ESO is worth substantially less to a risk-averse and poorly diversified employee than it costs the firm.

Hall and Murphy (2000A) used their model to determine the value of ESOs to employees in various applications (see Hall, B. J. and Murphy, K. J., “Optimal Exercise Prices for Risk Averse Executives”, American Economic Review, (December 2000)(“Hall and Murphy [2000A]”). A drawback with this model is that for certain “deep in the money” ESOs, the value produced by this model can be less than the option's intrinsic value at the grant date. To cure this deficiency, Hall and Murphy (2000B) extended the Lambert et al. model to reflect the possibility of early exercise. However, their model does not address the other features of ESOs and does not provide a means for calibrating the model to observed behavior.

To address non-traditional ESO features, Johnson and Tian (2000) provide formulas for valuing most of the non-traditional types of ESOs, including indexed options, performance vested options, repriceable options and purchased options. (See, Johnson, S. A. and Tian, Y. S., “The Value and Incentive Effects of Nontraditional Executive Stock Option Plans,” Journal of Financial Economics, Vol. 57, 2000, pages 3-34, (2000))(“Johnson and Tian [2000A]”) All of their models assume that the ESOs are European (i.e., can only be exercised at the options' expiration date). Also, their models do not address the other features of ESOs, such as vesting and forfeiture, do not address model calibration, and value ESOs only from the perspective of the company.

### BRIEF SUMMARY OF THE INVENTION

The present invention is directed to solving the above-mentioned problems and deficiencies by providing a novel computer system and computer program for determining the value of ESOs and the optimal exercise of ESOs.

The method of the present invention is designed to overcome the limitations of the traditional ESO valuation models by providing a system and method that:

Explicitly reflects the unique features that differentiate ESOs from ETOs;

Models these features in a comprehensive and rigorous manner based on financial and economic principles; and

Grounds the model in reality by enabling the user to calibrate the model to observed measures of exercise and forfeiture behavior. (Unlike ETOs, ESOs are not traded. Hence, no market price exists that can be used to calibrate the model. Consequently, it is necessary to use observed measures of exercise and forfeiture behavior, such as the expected option life, expected time-to-exercise, the expected ratio of the stock price at exercise to the strike price and the probability that the option is forfeited or expires worthless, to calibrate ESO valuation models.)

The present invention uses as a basis that the price of the underlying stock evolves according to a binomial tree and that employees make exercise decisions to maximize the expected utility of terminal wealth. The binomial tree representation has been chosen because it provides the invention the flexibility required to address the unique features of ESOs discussed above, especially the early exercise feature.

The present invention can be calibrated by adjusting calibration parameters to correctly predicts observed measures of forfeiture and exercise behavior. The calibration parameters include a parameter describing the ESO holder's risk aversion and non-option wealth.

Once the exercise decisions have been determined, the ESOs are valued by using either the standard risk-neutral backward induction methodology (to determine the cost of the ESO to the company) or the certainty equivalent method (to determine the value of the ESO to the employee). In addition to ESO valuation, the present invention also develops the joint distribution of exercise and forfeiture behavior at each node in the binomial tree. (It should be noted that while valuation is based on risk-neutral probabilities, the joint exercise and departure distribution is based on actual or risk-adjusted probabilities.) As a consequence, the model is able to compute a wide variety of measures of employee exercise behavior including:

Expected option life;

Expected time-to-exercise;

Expected ratio of the stock price at exercise to the strike price;

Probability of forfeiture before and after vesting;

Probability the option expires worthless; and

Probability of normal and forced exercise each period after vesting. (Forced exercise occurs when employees must either exercise or forfeit their ESO, shortly after leaving the firm.)

Yet further, the present invention is able to value ESOs that include non-traditional features, such as performance vesting, indexed ESOs and purchased ESOs. However, unlike the models reported in the literature, which tend to be European in character, this model reflects the possibility of early exercise.

### BRIEF DESCRIPTION OF THE DRAWINGS

FIG. 1 shows a block diagram of the present invention.

FIGS. 2-3 show exemplary inputs and output to a computer system practicing the present invention;

### DETAILED DESCRIPTION OF THE INVENTION

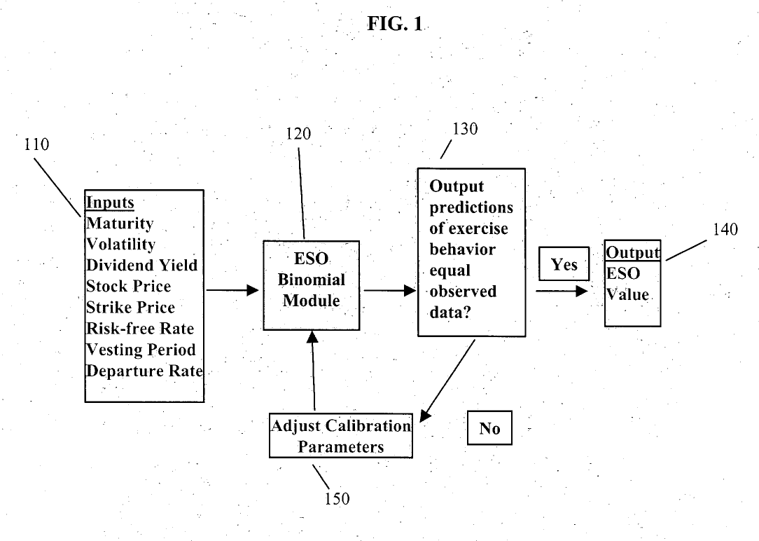

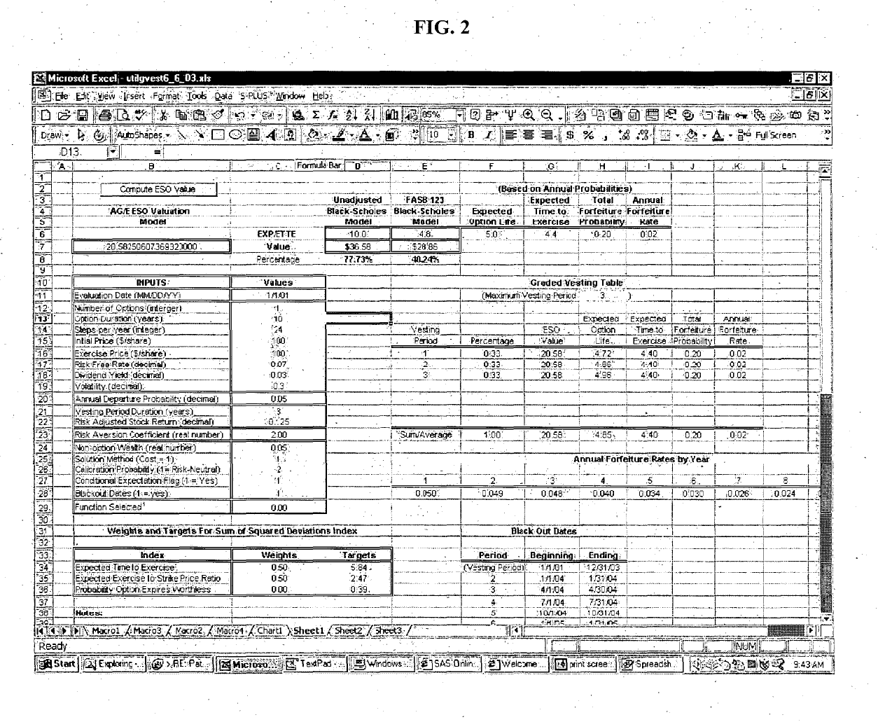

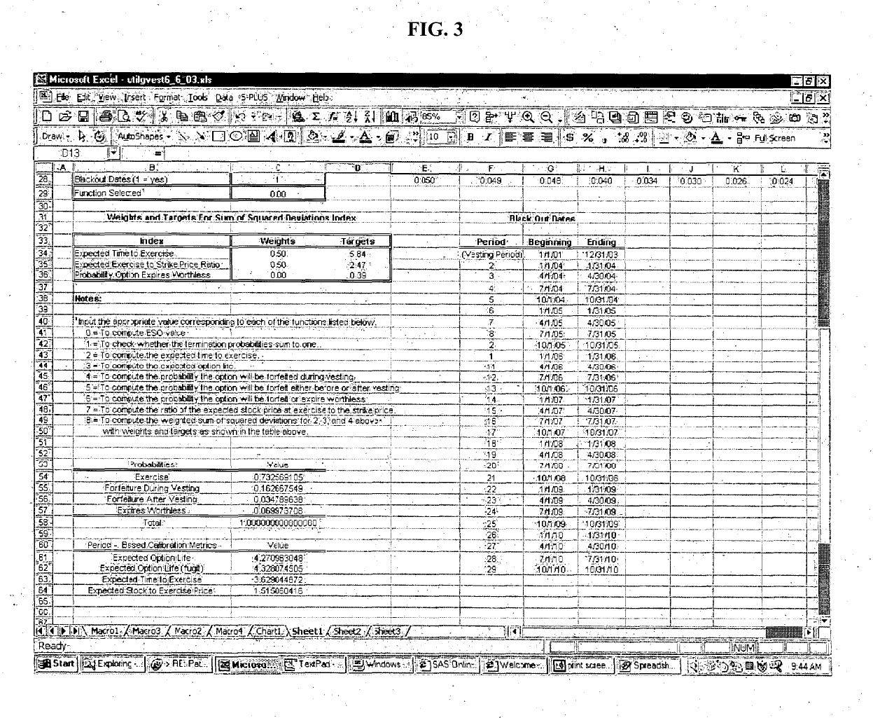

FIG. 1 shows an exemplary block diagram of the present invention. In particular, ESO binomial module 120 receives as inputs 110 data such as maturity, volatility, dividend yield, stock price, strike price, risk-free price, vesting period, and departure rate. These inputs are illustrative only and are not intended to be an exhaustive list of inputs. Module 120 then uses inputs 110 to generate output 130 which is the prediction of exercise behavior. This is then presented to ESO value module 140 to generate an ESO value based, on inputs 110.

To calibrate the system, if the output 130 matches observed data, then the system outputs an ESO value from ESO value module 140. If the output of output 130 does not comport with observed data, then selected calibration parameters are adjusted in module 150 and input into ESO binomial module 120.

The present invention may be implemented in whole or in part on computer systems running, for instance, a MICROSOFT EXCEL spreadsheet. The present invention may also be implemented using a programming language such as C or C++, or other computer programming language, to create a program to run on the computer system. Preferably, the computer system has at least one monitor is attached and is connected to a network and other input/output devices, such as a keyboard or monitor or printer, for receiving input parameters and outputting ESO values. It is not necessary, however, to implement the present invention on a networked computer, but a standalone computer may also be used as well as various handheld devices such as personal digital assistants (“PDA”) such as those manufactured by PALM or HANDSPRING and using the PALM OS or other PDAs utilizing the MICROSOFT WINDOWS CE operating system. At least one input is provided for receiving modeling parameters.

### A. General Methodology

The present invention is designed to explicitly reflect the unique features of ESOs. As previously noted, the present invention assumes that the stock price evolves according to a binomial tree. With a binomial tree, one assumes that during each time step of length h, the price of the underlying stock will either increase from its current level of S to u·S or decrease from S to d·S, where

u>e^{rh}>d

and r is the annual risk-free rate. U and d are determined by the equations

u=e^{vol\sqrt{h}}

$$d = \frac{1}{u}$$

where vol is the standard deviation (“volatility”) of the return on the underlying stock price,

$$h = \frac{T}{N}$$

is the length of each period, N is the number of time periods and T is the option's duration. The probability that the stock price will increase is given by

$$q = \frac{{ⅇ}^{{( μ - δ )}_{h}} - d}{u - d} ,$$

where q is the actual (as opposed to risk-neutral) probability of an up-move, u is the expected risk-adjusted return on the underlying stock, and δ is the annual dividend yield. (Note, the risk-adjusted return could be obtained from the CAPM.)

In the present invention, an ESO is valued by using backward induction with terminal boundary conditions computed by the formula:

V(N,j)=U(W_{Nj}),

where

V(N, j)=the utility of terminal wealth in period N, given that j up-moves have occurred

U(W_{N})=the utility of terminal wealth. It is assumed that the employee has constant relative risk aversion ρ so that

$$U ( W ) = \frac{{W}^{1 - ρ}}{1 - ρ}$$

when ρ≠1 and U(W)=LN(W) when ρ=1.

W_{Nj}=the employee's terminal wealth in period N, given by

$${W}_{Nj} = {W}_{0} \cdot {ⅇ}^{rhN} + {n}_{0} \cdot {( {S}_{Nj} - X )}^{+}$$

$${Y}^{+} = \{ \begin{matrix}Y if Y \geq 0 \\ 0 otherwise\end{matrix}$$

W₀=the employee's initial non-option wealth, which in period N will have grown to W₀e^{rhN} if the wealth is invested at the risk-free rate for N periods, each of length h

N₀=the number of ESOs held by the employee

S_{Nj}=the level of the firm's stock price in period N if the stock has make j up-moves. S_{Nj} is given by S_{Nj}=S₀·u^{j}d^{N-j}.

For any period n, (n=N−1 to 0), the value of the optional return function is computed recursively, starting with the continuation value

VC=V(n+1,j+1)·q+V(n+1,j)·(1−q),

where all of the terms have been previously defined. Notice that the continuation value is based on the risk-adjusted probability of an up-move since the “value” function reflects risk aversion. If the period n is prior to vesting, then V(n, j) is given by

V(n,j)=VC·P_{stay}+(1−P_{stay})·U(W(0)e^{rhN}).

Where P_{stay} is the probability that the employee stays with the firm during the time period. It is calculated from the equation P_{stay}=(1−P_{dep})^{h} where P_{dep} is the annual departure rate. Notice that if the employee leaves prior to vesting, the ESOs are forfeited but the employee still receives utility from initial wealth that will have grown to W(0)e^{rhN}.

If instead, n is after vesting, then V(n, j) is given by

V(n,j)=P_{stay}·MAX(V_{c},Vₑ)+(1−P_{stay})·Vₑ.

The equation says that if the employee does not leave (this happens with probability P_{stay}), then the employee will exercise the option if the utility of terminal wealth from doing this, V_{e,} is greater than the utility of terminal wealth from continuing to hold the option, V_{c}. If the employee leaves the firm, then the employee would exercise the option if it is in the money and forfeit the option if it is out of the money. In the above formula, Vₑ is given by

Vₑ=U(W(0)e^{rhN}+MX·e^{rh(N-n)}),

where

MX=(Sₙⱼ−X)⁺

Sₙⱼ=S₀·u^{j}d^{n-j}

and all of the remaining terms have previously been defined. We use variable eev(i,j) to describe the employee's exercise strategy where eev(i,j)=1 if Vₑ>V_{c} and zero otherwise. Once the exercise strategy has been determined, both the cost of the ESO to the company and the value of the ESO to the employee can be determined. The cost of the ESO to the company is computed using the same backward, risk-neutral induction process used to value exchange-traded options.

For the terminal period, N, we compute

F(n,j)=(S_{Nj}−X)⁺, j=0, . . . N.

The value for any other period, n=N−1 to 0 is again computed recursively, from the formula below

CV=e^{-r·h}·(F(n+1,j+1)·P+F(n+1,j)·(1−P)).

where P, the probability of an increase in the stock price, is computed by the risk-neutral probability

$$P = \frac{{ⅇ}^{( r - δ ) h} - d}{u - d} ,$$

If n is prior to vesting, then F(n,j) is given by

F(n,j)=P_{stay}·CV.

If n is after the vesting period, then F (n,j) is given by

F(n,j)=P_{stay}·[MX·eev(n,j)+CV(1−eev(n,j))]+(1−P_{stay})·MX.

The equation says that if the employee stays during period n (which occurs with probability P_{stay}), then the employee receives the option's intrinsic value of MX=(Sₙⱼ−X)⁺ if the option is exercised (i.e., eev(n,j)=1) or the continuation value, CV, if the option is not exercised. If the employee does not stay, which happens with probability 1−P_{stay}, then the employee would exercise the option if it is in the money and receive the option's intrinsic value of MX=(Sₙⱼ−X)⁺. The cost of the option is obtained from F (0,0).

The value of the option to an employee is obtained by using a certainty equivalent methodology. That is, the present invention solves for the increment to the employee's initial wealth that will produce the same expected utility of terminal wealth as that produced by following the optimal exercise policy.

### Calibrating the Model to Observed Measures of Forfeiture and Exercise Behavior

To calibrate the present invention, the starting point is to compute the joint probability of the various possible outcomes that can occur at each node of the binomial tree (i.e., the LSO will be exercised, forfeited or will expire worthless). These probabilities are computed as follows. First, given the values eev(n,j), from the previous section, we determine the smallest value of j (equal to bv(n)) for which eev(n,j) is one. The points (n, bv(n)) are the “exercise boundary” for the problem. If the price of the stock equals or exceeds this boundary, then the option should be exercised.

Second, the system-computes variables P(n, j, k), which are defined as the unconditional probability of j up-moves in period n. The variable k will take on a value of one if the employee leaves at the beginning of period n and a value of zero otherwise.

The values for P(n, j, k) are computed recursively starting with the initial conditions

P(1,0,1)=1−P_{stay} [1a]

P(1,0,0)=P_{stay}·(1−q) [1b]

P(1,1,0)=P_{stay}·q [1c]

where q is the actual (as opposed to risk-neutral) probability of an up-move.

Equation [1a] says that the probability of no up-moves and the employee leaving at the beginning of period one is 1−P_{stay}. Equation [1b] says that the probability of a down-move and the employee not leaving after period one is P_{stay}·(1−q). Finally, Equation [1c] says that the probability of an up-move and the employee not leaving after period one is P_{stay}·q.

The value of P(n, j, k) for the other periods is computed from the equations

P(n, j,1)=P(n−1,j,0)·(1−P_{stay}) [2a]

P(n0,0)=P(n−1,0,0)·P_{stay}·(1−q) [2b]

P(n,n,0)=P(n−1,n−1,0)·P_{stay}·q·deltaᵤ [2c]

P(n,j,0)=P(n−1,j−1,0)·P_{stay}·q·deltaᵤ+P(n−1,j,0)·P_{stay}·(1−q)·delta_{d} [2d]

where

j=0,1, . . . m(n)

$$m ( n ) = \{ \begin{matrix}n \\ bv ( n )\end{matrix}$$

if exercise is either not permitted or not economic otherwise

$${delta}_{u} = \{ \begin{matrix}0 & if an \text{up} \text{-} move is not possible \\ 1 & otherwise \end{matrix}$$

$${delta}_{d} = \{ \begin{matrix}0 & if an \text{down} \text{-} move is not possible \\ 1 & otherwise \end{matrix}$$

Equation [2a] shows that the probability of departure in period n with j up-moves equals the probability that the employee does not leave the company during period n−1 and j up-moves have been made multiplied by the probability that the employee leaves at the beginning of period n, (1−P_{stay}). Equations [2b] and [2c] have similar interpretations.

Equation [2d] states that the probability of j up-moves and that the employee has not left the firm by the end of period n, P(n,j,0), equals the probability of j−1 up-moves in period n−1 and the employee did not leave during that period multiplied by the probability of an up-move, q, and the probability that the employee stayed during period n, P_{stay}, and an up-move from period n−1 to period n is possible plus an analogous expression for the joint event that there were j up-moves in period n−1, the employee remained during period n, there was no up-move in period n and the move from node (n−1, j) to node (n, j) was possible. (For example, deltaᵤ would equal zero if the point (n−1,j−1) was on the exercise boundary since the option would have been exercised at this point and a subsequent move to the point (n,j) would be impossible.)

Equation [3] is the basic building block for computing various measures of forfeiture and exercise behavior. For example, the probability that the option does not vest is

$${\sum }_{n = 0}^{{t}_{v}^{*}} {\sum }_{j = 0}^{n} P ( n , j , 1 ) , \qquad [ 3 ]$$

where

$${t}_{ v}^{*} = I N T ( \frac{{t}_{v}}{h} )$$

t_{ν}=the vesting period in years

INT(X)=the integer portion of the variable X

Similarly, the probability of unforced exercise in period n is P(n,bv(n),0), n=1, 2, . . . N.

The probability that the option is forfeited (i.e., the employee leaves and the option is out of the money) after vesting is

$${\sum }_{{t}_{v}^{*} + 1}^{N} {\sum }_{j = 0}^{{j}^{*} n} P ( n , j , 1 ) ,$$

where j*(n) is the largest value of j at time n for which the option's intrinsic value is negative. The probability that the ESO expires worthless is given by

$${\sum }_{j = 0}^{{j}^{*} n} P ( N , j , 0 )$$

The expected time-to-exercise is calculated as

$$\frac{{\sum }_{n = {t}_{v}^{*} + 1}^{N} ( n \cdot h ) \cdot {P}_{tot} ( n )}{{\sum }_{{n}^{′} = {t}_{v}^{*} + 1}^{N} {P}_{tot} ( {n}^{′} )} ,$$

where Pₜₒₜ(n), the probability of total exercise (i.e., unforced and forced), is given by:

$${P}_{t o t} ( n ) = \{ \begin{matrix}{\sum }_{j = {j}^{*} ( n ) + 1}^{m ( n )} [ P ( n , j , 0 ) + P ( n , j , 1 ) ] , n = N \\ {\sum }_{j = b v ( n )}^{m ( n )} P ( n , j , 0 ) + {\sum }_{j = {j}^{*} ( n ) + 1}^{m ( n )} P ( n , j , 1 ) , n = {t}_{ v}^{*} + 1 \\ {\sum }_{{j}^{*} ( n ) + 1}^{m ( n )} P ( n , j , 1 ) + P ( n , b v ( n ) , 0 ) , n \neq N o r n \neq {t}_{ v}^{*} + 1\end{matrix}$$

Note that the expected time-to-exercise is computed as the conditional expectation (conditioned on the event that exercise occurs after the vesting period) of the various possible exercise events. The conditional expectation is used because it is assumed the data will be in this format. That is, we assume the exercise data will consist of possible exercise times, which by definition will occur after vesting, and their frequency of occurrence. These data can be viewed as the realizations from the conditional distribution of all possible exercise times, conditioned on exercise occurring after the vesting period. A similar approach is used to calculate the expected ratio of the stock price at exercise to the option's strike price.

The present invention also allows multiple measures to be used in combination. For example, if \overline{X}ᵢ is the average observed value for the three basic measures (i.e., time-to-exercise, proportion of options that are forfeited or expire worthless, and average ratio of stock price at exercise to the strike price) and \hat{X}ᵢ is the model-produced value, then the system may be calibrated by minimizing the weighted sum of the squared deviations between the observed indices and the model-produced value through the formula

$${\sum }_{i = 1}^{3} {W}_{i} \cdot {( {\overline{X}}_{i} - {\hat{X}}_{i} )}^{2} ,$$

where Wᵢ equals the weight associated with the i^{th} measure.

### More Advanced Model Features

This section discusses more advanced features of ESOs that the present invention is designed to address.

### A. Stochastic, Departure Rates

This feature allows the annual departure rate to vary with the level of the stock price instead of being an exogenous input. This feature is important because the probability of departure is greatly affected by the level of the stock price. The departure rate is modeled as a logit function that depends upon the level of the stock price. The logit function, which can be viewed as the conditional probability of departure, is calibrated such that the unconditional probability of departure is equal to a desired annual value.

### B. Constant Dividend Amounts

The present invention assumes that the dividends paid by the firm to holders of its stock are proportional to the price of the underlying stock. This assumption is often made for convenience and because it enables the binomial tree-based models to recombine. (A binomial tree is said to recombine if an up-move followed by a down-move will end up at the same place as a down-move followed by an up-move. If a tree does not recombine then the number of nodes grows exponentially rather than linearly if the tree recombines.)However, in reality, dividends are usually not paid continuously. To address this situation, the model allows dividends to be paid in discrete amounts according to a known schedule.

### C. Time Varying Parameters

As discussed earlier, given the duration of most ESOs, it may be unreasonable to assume that the parameters of the model will remain constant. To deal with this situation, the present invention allows the key parameters to vary with time. The assumption that the strike price can vary is especially important since some plans assume that the strike price will vary according to a prescribed schedule. For the most part, allowing the parameters to vary with time does not cause any difficulty. However, allowing the volatility of the underlying stock price to vary causes difficulty because it prevents the tree from recombining. Fortunately, by adjusting the time scale, it has been possible to construct a tree that exhibits time varying volatility yet still allows the tree to recombine.

### D. Graded Vesting

The description of the present invention above assumes cliff vesting. That is, all options are assumed to vest at the same time (e.g., three years from the grant date). In yet another feature of the present invention, it can also be used to model ESOs that are subject to graded vesting. (By graded vesting we mean that a specific percentage of the options will vest over a certain number of years (e.g., one third of the options will vest each year for three years))

To handle graded vesting, the present invention determines the optimal joint exercise strategy for each of the vesting dates using dynamic programming. This extension both simplifies the solution process and provides an optimal solution in instances where the value obtained by optimizing across all exercise dates may be different from the solution obtained by optimizing each vesting date separately.

### E. Non-Traditional Features

Lastly the present invention has been extended to allow non-traditional ESOs to be valued, including:

Indexed ESOs

Repriceable ESOs

Purchased ESOs

Performance vested ESOs

### 1. Indexed ESOs

With an indexed ESO, the strike price is allowed to vary according to an index. The index is usually assumed to evolve according to a process that is similar to the stock price process. The models reported in the literature (see Johnson and Tian [2000A or 2000B]) for valuing indexed options assume that the option can be exercised only at its terminal date. As a consequence, these models are not applicable to indexed ESOs, which can be exercised at any time after vesting. To overcome this limitation, the present invention value indexes ESOs based on equations that value an American version of an exchange option (i.e., the option to exchange to one asset [the index] for another asset [the underlying stock price]).

### 2. Repriceable ESOs

Repriceable ESOs allow the firm to reset the strike price to the current price of the stock if the ESO is too far under water. In the literature, repriceable options have been valued by assuming the strike price will reset if the stock price drops below the strike price by more than a given amount (termed “trigger price”). Since the level at which the strike price will be reset is generally unknown, we have taken a different tack. The present invention assume that the probability that the strike price will be reset is an increasing function of the difference between the strike price and the stock price. The problem is solved by using dynamic programming, with the state space expanded to reflect the different possible values the strike price can take at each node.

### 3. Purchased ESOs

With a purchased ESO, the employee pays a fraction of the strike price at the grant date and the remainder of the strike price when the option is exercised. On feature of the present invention is to handle this so that it can value purchased ESOs. This has been done by setting the strike price, X, equal to X·(1−f) and subtracting f·X from the computed value of the ESO, where ƒ is the fraction of the strike price that must be paid by the employee at the grant date.

### 4. Performance vested ESOs

With a performance vested ESO, the option does not vest until the stock price hits a preset limit. In the literature (see Johnson and Tian [2000B]), performance vested options have been modeled as European-style barrier options. Yet another feature of the present invention is that it can value performance vested ESOs. This has been done by treating them as American-style “up and in” barrier options.

### Comparison of the Model Results with Those of Traditional Models

This section compares results based on the present invention with those of both the Black-Scholes and the modified Black-Scholes models. The comparisons are based on the data shown in Table A below.

TABLE A
Model Inputs

| | |
|---|---|
| Stock price | $35 |
| Strike price | $35 |
| Option duration | 10 years |
| Volatility | 32 percent |
| Dividend yield | 3 percent |
| Risk-free rate | 5 percent |
| Annual departure rate | 3 percent |
| Vesting period | 3 years |
| Expected option life | 5 years |

The data in Table A are based on values reported in the literature (See Hall and Murphy 2000B) and 10K filings of companies that have stated their intention to expense the cost of ESOs.

TABLE B
Effect of Departure Rate on ESO Value for ESO Binomial
and Black-Scholes Models

| | | | | | | Modified | |
|---|---|---|---|---|---|---|---|
| | | | | | | Black- | |
| | | | | | | Scholes | |
| | Extended | | | Modified | | Value with | |
| | Binomial | Black- | | Black- | | Adjustment | |
| Departure | Model | Scholes | Percent | Scholes | Percent | for | Percent |
| Rate | Value | Value | Difference | Value | Difference | Forfeiture | Difference |
| 3% | $7.46 | $11.64 | 56% | $9.53 | 28% | $8.70 | 17% |
| 10% | $5.92 | $11.64 | 97% | $9.38 | 58% | $6.84 | 16% |

Table B shows the affect on ESO cost of variations in the departure rate for the ESO Binomial model, the Black-Scholes model, the modified Black-Scholes model, and the modified Black-Scholes model adjusted for forfeiture based on various departure rates. (A departure rate of three percent is fairly typical for mature companies. High tech companies can have departure rates as high as 25 percent.) The Black-Scholes model overstates the cost of ESOs by more than 56 percent at a three percent departure rate and roughly 100 percent at a 10 percent departure rate. Similarly, the modified Black-Scholes model overstates the cost of ESOs by roughly 30 percent for a three percent departure rate and roughly 60 percent for a 10 percent departure rate. Finally, the modified Black-Scholes model adjusted for forfeiture overstates the cost of ESOs by roughly 16 percent for both departure rates.

TABLE C
Effect of Vesting Period on ESO Value for Extended Binomial
and Black-Scholes Models

| | | | | | | Modified | |
|---|---|---|---|---|---|---|---|
| | | | | | | Black- | |
| | | | | | | Scholes | |
| | ESO | | | Modified | | Value with | |
| | Binomial | Black- | | Black- | | Adjustment | |
| Vesting | Model | Scholes | Percent | Scholes | Percent | for | Percent |
| Period | Value | Value | Difference | Value | Difference | Forfeiture | Difference |
| 1 year | $5.10 | $11.64 | 128% | $7.64 | 50% | $7.41 | 45% |
| 2 years | $6.55 | $11.64 | 78% | 8.74 | 33% | $8.23 | 26% |
| 3 years | $7.46 | $11.64 | 56% | $9.53 | 28% | $8.70 | 17% |

Finally, Table C shows the affect on ESO cost of changes in the vesting periods for the ESO Binomial model, Black-Scholes model, modified Black-Scholes model and modified Black-Scholes model adjusted for forfeiture. The Black-Scholes model overstates the cost of the ESO by 128 percent, 78 percent and 56 percent for vesting periods of one, two and three years, respectively. The overstatements using the modified Black-Scholes model range from 50 percent to 28 percent. Finally, the modified Black-Scholes model with an adjustment for forfeiture overstates the cost of an ESO by from 45 percent to 17 percent as the vesting period goes from one to three years.

The relationship between vesting period and ESO cost (see ESO Binomial model column) underscores the difference between ESO and ETOs. For ETOs cost would decline with increases in vesting period. This occurs because increases in the vesting period limit the investor's ability to make value—enhancing exercise decisions. In order to calibrate the model to the five year expected option life required a risk aversion parameter of approximately 2, which implies that the employee is moderately risk averse. At this level of risk aversion, the employee will exercise ESOs earlier than would a unconstrained investor. By preventing such early exercise, increases in vesting period will tend to increase the value and cost of ESOs.

### Computer Implementation

For speed and accuracy, the models described above have been implemented in C++ with input and output provided by Microsoft's Excel. That is the model inputs are received from Excel, the model outputs provided to Excel and the solution algorithm is written in C++.

The present invention is implemented in combination of hardware and software. Preferably, the present invention is implemented in one or more computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device. It will be appreciated that the system, method of operation and product may vary as to the details of its configuration and operation without departing from the basic concepts disclosed herein.

In the manner described above, the present invention thus provides a system and method to transfer data. While this invention has been described with reference to the preferred embodiments, these are illustrative only and not limiting, having been presented by way of example. Other modifications will become apparent to those skilled in the art by study of the specification and drawings. It is thus intended that the following appended claims include such modifications as fall within the spirit and scope of the present invention.

What we claim is:

1. A method for determining a value of employee stock options comprising:
a computing module;
inputting into said computer module one or more initial parameters comprising a maturity date, a volatility factor, a dividend yield, an initial stock price, a strike price, a risk-free price, a vesting period,l a departure rate, and a blackout date;
outputting from said computing module one or more of an employee optimal exercise strategy, a probability of departure, a probability of forfeiture, an ESO value, and one or more calibration metrics including an expected option life, a ratio of a stock price to strike price, an expired worthless probability, and a future stock price;

2. A method of claim 1 further comprising:
computing an employee exercise boundary from said one or more initial parameters;
computing said employee optimal exercise strategy by comparing said future stock price with said employee exercise boundary;
computing an unforced exercised probability from said employee optimal exercise strategy;
computing said probability of forfeiture and a probability of forced exercise from said probability of departure, said vesting period, said strike price and said future stock price at a date of departure;
computing an ESO value from said probability of forfeiture, said probability of forced exercise and said unforced exercised probability.

3. A method of claim 2 further comprising:
calibrating said one or more initial parameters using a risk aversion factor, an employee wealth parameter and said departure rate.
